(19) United States
(12) Patent Application Publication
(10) Pub. No.: US 2004/0119339 A1
(43) Pub. Date: Jun. 24, 2004

(54) Adaptive power supply system with multiple input voltages

(76) Inventor: James Sytwu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/429,839

(22) Filed: May 6, 2003

(30) Foreign Application Priority Data
Dec. 20, 2002 (TW) 91136859

(51) Int. Cl. H02J 1/10; H02J 3/00

(52) U.S. Cl. 307/28

(57) ABSTRACT

An adaptive power supply system is designed to adaptively supply an electrical power from a plurality of input voltages to an electronic device in accordance with the load of the electronic device. The power supply system includes first and second groups of voltage conversion circuit loops, having input terminals respectively connected to a first input and second input voltages. Each voltage conversion circuit loop includes a switching circuit to which an associated control signal from a controller is coupled for controlling on/off states of the switching circuits. Output terminals of the first and second groups are connected to a common node point to provide a single output voltage to the electronic device.

### BACKGROUND OF THE INVENTION

1. Field of the Invention

The present invention relates generally to a power supply system, and in particular to an adaptive power supply system capable of adaptively supplying an output voltage from multiple input voltages to an electronic device.

2. Description of the Prior Art

Electronic equipment, such as computer systems, measuring systems and control equipment, require a power supply to provide required electrical power to the electronic equipment. The quick development of the electronic industry leads to versatility of power required by different electronic devices in single electronic equipment. Thus, the power supply system of the electronic equipment gets complicated in order to supply for example a number of different levels of voltages to different electronic devices.

FIG. 1 of the attached drawings shows a simplified block diagram of a conventional power supply system incorporating a circuit board of a computer device. The power supply system comprises a power supply device 11 connected to an AC power source ACV. The power supply device 11 converts the AC power of the AC power source ACV into DC power, and supplies a plurality of DC powers with different voltage levels to a connector 13 via power lines 12.

In the example illustrated in FIG. 1, the DC voltages that are supplied to the connector 13 by the power supply device 11 include multiple voltage levels of +3.3V, +5V, +12V, −5V and −12V. Currently, power supplied from the connector 13 to a central processing unit 16 is +12V, which is processed by a voltage conversion circuit 15 to provide a DC voltage V0 (such as +1.5V) to a central processing unit 16 that is mounted on a circuit board 14. An example of the power supply device 11 is a switching power supply mainly composed of a rectifier, a transformer, one or more switches, and a filter, which is well known and commonly used.

A number of power lines 12 are connected between the power supply device 11 and the connector 13 for providing different voltages to the connector 13. Each power line 12 is designed to have predetermined rated output current and peak output current, of which an example is given in the following table I:

TABLE I

| | | Rated Output | Peak Output |
|---|---|---|---|
| DC Voltage | Output Power | Current | Current |
| +3.3 V | 50 W | 15 A | 20 A |
| +5 V | 125 W | 25 A | 30 A |
| +12 V | 120 W | 10 A | 16 A |
| −5 V | 2.5 W | 0.5 A | 1.0 A |
| −12 V | 10 W | 0.8 A | 1.5 A |

The designed values of the rated output current and peak output current limit the power that can be supplied through each particular power line. A power consumption exceeds the maximum power that can be taken by the power line would lead to damage to the power line.

The rapid development of the electronics brings increasing demand of power consumption of electronic devices, which is sometimes not affordable by the conventional power supply system described above. Further, the conventional power supply system also makes it difficult to upgrade electronic device, which may require greater power consumption exceeding what can be taken by the original power supply system. For example, the central processing unit 16 that is mounted on the circuit board 14 may be replaced by a higher level and faster central processing unit that requires a current greater than the rated output current of the voltage level +12V. Besides upgrading the central processing unit, overclocking the central processing unit also requires greater power consumption than regular operation. In any cases, the consequent power consumption may simply exceed what can be taken by any individual power line of the conventional power supply system.

A straightforward solution to the above problem is to replace the original power supply system with a new power supply system that is capable to supply larger power. This definitely increases costs. In addition, such a large power supply may simply over-performance for certain applications.

In most cases, although one of the power lines of the conventional power supply system may occasionally get overloaded. The other power lines may take only small load or no load at all at the same time when the one of the power lines is overloaded. Thus, more fully exploit the utilization of all power lines, rather than a single particular one, may allow for enhancement of overall performance of the power supply system without replacing any parts thereof.

Examples of prior art power supply system are described in U.S. Pat. No. 6,433,443 which discloses a switching power supply that provides multiple DC levels of output voltage wherein electrical current that is supplied from an AC power source is processed to provide more than two DC voltages at output terminals. U.S. Pat. No. 6,477,063 discloses a switching power supply having a multiplicity of DC outputs having different voltage levels. U.S. Pat. No. 5,751,564 discloses a switching power supply having multiple input voltage levels, which obtains electrical power from an AC power source or a DC power source. The power is then converted into a DC voltage having a desired level at an output terminal. All these references do not teach how to adaptively and selectively supply electrical power of predetermined voltage level from one or more inputs to common, a destination output terminal.

Thus, the present invention is aimed to make use of additional power lines of a power supply system to supplement excessive power consumption required by a particular electronic device without replacing the power supply system.

### SUMMARY OF THE INVENTION

Thus, a primary object of the present invention is to provide a power supply system for adaptively supplying power through additional power lines of a power supply system in order to adaptively supplement excessive power consumption required through a particular power line.

Another object of the present invention is to provide a power supply system that allows for adaptive supply of increased power to an upgraded electronic device without replacing power supply system.

To achieve the above objects, in accordance with the present invention, an adaptive power supply system is arranged between an external power source that supplies first and second input voltages and an electronic device for adaptively supplying power to the electronic device in accordance with the load of the electronic device. The adaptive power supply system comprises first and second groups of voltage conversion circuits, having input terminals respectively connected to the first and second input voltages. Each voltage conversion circuit comprises a switching circuit to which an associated control signal from a controller is coupled for controlling on/off states of the switching circuits. Output terminals of the first and second groups are connected to a common node point and combined together to provide a single output voltage to the electronic device.

### BRIEF DESCRIPTION OF THE DRAWINGS

The present invention will be apparent to those skilled in the art by reading the following description of a preferred embodiment of the present invention, with reference to the attached drawings, in which:

FIG. 1 is a simplified block diagram illustrating a conventional power supply system incorporates a circuit board of a computer device;

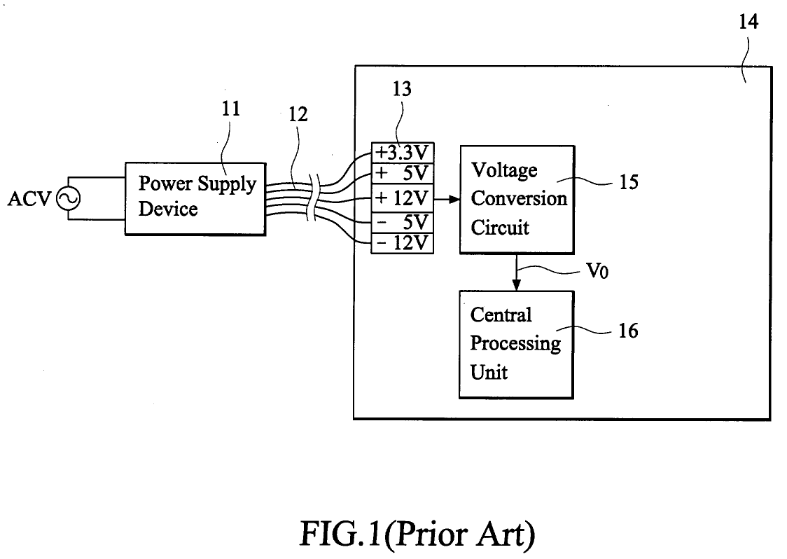

FIG. 2 is a simplified block diagram illustrating an adaptive power supply system incorporates a circuit board of a computer device of the present invention; and

FIG. 3 is a schematic block diagram of a control circuit of the adaptive power supply system in accordance with a preferred embodiment of the present invention.

### DETAILED DESCRIPTION OF THE PREFERRED EMBODIMENTS

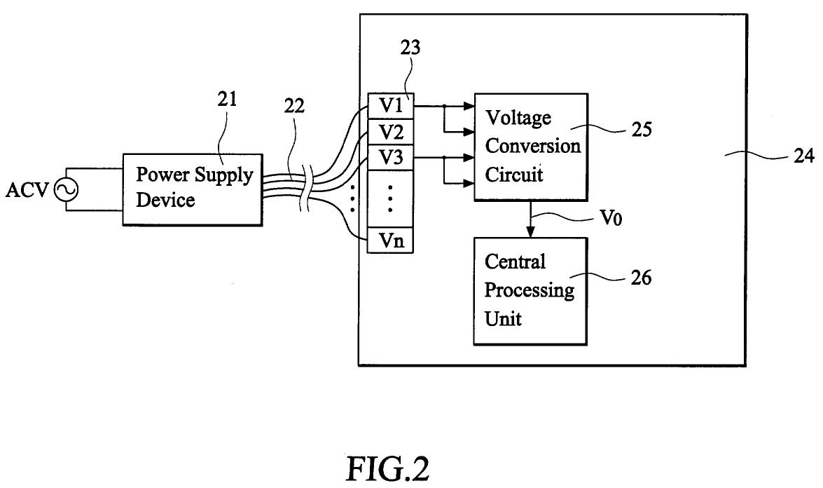

With reference to the drawings and in particular to FIG. 2, an adaptive power supply system incorporating a circuit board of a computer device in accordance with a preferred embodiment of the present invention is shown. The adaptive power supply system is able to supply an adaptive power to the circuit board. The power supply system of the present invention comprises a power supply device 21 that receives electrical power from an AC power source ACV and that supplies a number of different DC input voltages V1, V2, V3, . . . , Vn to a connector 23 via power lines 22 respectively. The power lines 22 are connected between the power supply device 21 and the connector 23 whereby the connector 23 supplies at different terminals thereof the DC input voltages to the circuit board 24. An example of the power supply device 21 is a switching power supply that is well known in the art and no further detail is needed herein.

In accordance with the present invention, a voltage conversion circuit 25 is connected between the connector 23 and an electronic part that consumes electrical power, such as a central processing unit 26 of a computer device. The voltage conversion circuit 25 receives at least two of the DC input voltages of the connector 23 and in turn provides a DC output voltage V0 to the central processing unit 26 mounted on the circuit board 24. The voltage conversion circuit 25 adaptively supplies DC power from either one or any combination of the DC input voltages to the central processing unit 26 based on the power requirement or load of the central processing unit 26.

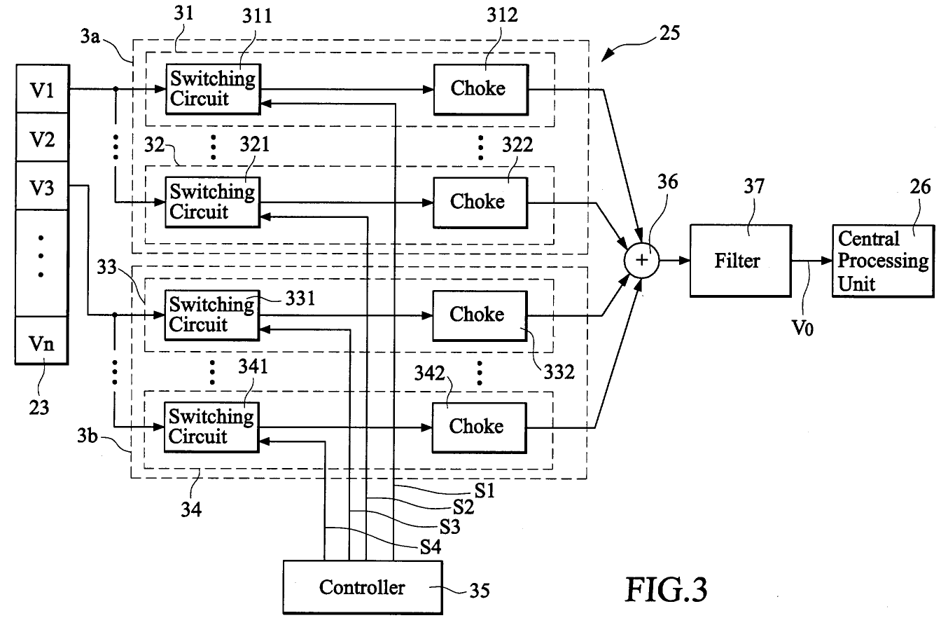

Also referring to FIG. 3, the voltage conversion circuit 25 comprises a number of voltage conversion circuit loops 31, 32, 33, 34, each comprised of a switching circuit 311, 321, 331, 341 and a choke 312, 322, 332, 342 connected in series. A controller 35 is coupled to the switching circuits 311, 321, 331, 341 and provides control signals S1, S2, S3, S4 to the switching circuits 311, 321, 331, 341 for controlling the on/off states of the switching circuits 311, 321, 331, 341. In the embodiment illustrated, the controller 35 comprises a pulse width modulation (PWM) control circuit. The controller may comprise other control circuit having variable duty cycle.

The voltage conversion circuit loops 31, 32, 33, 34 are divided into two groups 3a, 3b, respectively including circuits 31, 32 and 33, 34 in the embodiment illustrated. Each voltage conversion circuit loop 31, 32, 33, 34 has an input terminal and the input terminals of the circuit loops 31, 32 or 33, 34 in the same group 3a or 3b are connected to each other and a selected one of the input voltages V1, V2, V3, . . . , Vn of the connector 23. For example and as illustrated in FIG. 3, the first group 3a includes voltage conversion circuit loops 31, 32 and the input terminals of the switching circuits 311, 321 of the voltage conversion circuit loops 31, 32 are connected to each other and the first input voltage V1 (such as +5V) of the connector 23, while the second group 3b includes voltage conversion circuit loops 33, 34 and the input terminals of the switching circuits 331, 341 of the voltage conversion circuit loops 33, 34 are connected to each other and the third input voltage V3 (such as +12V) of the connector 23

Each voltage conversion circuit loop 31, 32, 33, 34 has an output terminal on which a predetermined output voltage is supplied. The output voltages are supplied to a node 36 that is common to all the voltage conversion circuit loops 31, 32, 33, 34, and combined together as a single output voltage to the central processing unit 26. The output voltage may be further processed by a filter 37 for waveform shaping. The filter 37 outputs the output voltage V0 to the central processing unit 26.

The controller 35 operates in such a way that power from both groups 3a, 3b is selectively supplied to the central processing unit 26 with the same output voltage by controlling the on/off states of the switching circuits 311, 321, 331, 341. With the selective control of the switching circuits 311, 321, 331, 341 with the controller 35, power supplied to the central processing unit 26 can be adaptively changed in accordance with the power consumption requirement or load of the central processing unit 26 by selectively conducting groups 3a, 3b on. In other words, the central processing unit 26 is originally powered by the output voltage from the first group 3a which is received from the first input voltage of the connector 23. In case the power consumption of the central processing unit 26 exceeds the rated output current of the first group 3a, the controller 35 turns on the second group 3b and additional power is supplied to the central processing unit 26 wherein the additional power is obtained from the third input voltage V3 of the connector 23. Thus, the voltage conversion circuit 25 in accordance with the present invention is capable of adaptively supplying electrical power to an electronic device via additional power lines for meeting the power consumption requirement of the electronic device without modifying or changing any parts thereof or any parts of the power supply system associated therewith.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An adaptive power supply system for adaptively supplying an electrical power to an electronic device, comprising:
a controller for generating a plurality of control signals;
a plurality of voltage conversion circuit loops, each of which comprising at least one switching circuit and at least one chock connected in series, each switching circuit having an input terminal, each control signal of the controller being coupled to the switching circuit for selectively turning on/off the switching circuit; and
the voltage conversion circuit loops being divided into a plurality of groups comprising at least a first group and a second group, the input terminals of the switching circuits of the first group being connected together to a first input voltage, while the input terminals of the switching circuits of the second group being connected together to a second input voltage which is different from the first input voltage;
wherein the first group has an output terminal for providing the electronic device with a first output having a predetermined voltage level under the control of the controller and wherein the second group has an output terminal for selectively providing the electronic device with a second output of the predetermined voltage level under the control of the controller so as to supply a single output having the predetermined voltage level to the electronic device.

2. The adaptive power supply system as claimed in claim 1, wherein the controller comprises a pulse width modulation control circuit.

3. The adaptive power supply system as claimed in claim 1, wherein the first output provided by the first group and the second output provided by the second group further pass through a filter.

4. The adaptive power supply system as claimed in claim 1, wherein the first input voltages and the second input voltage are supplied by a switching power supply.

5. An adaptive power supply system for adaptively supplying an electrical power to an electronic device, comprising:
a power source supplying a plurality of input voltages comprising at least a first input voltage and a second input voltage;
a plurality of voltage conversion circuit loops, each of which comprising an input terminal and an output terminal; and
the voltage conversion circuit loops being divided into a plurality of groups comprising at least a first group and a second group, the input terminals of the voltage conversion circuit loops of the first group being connected together to a first input voltage, while the input terminals of the voltage conversion circuit loops of the switching circuits of the second group being connected together to a second input voltage which is different from the first input voltage;
wherein the output terminals of the voltage conversion circuit loops of the first group provides the electronic device with a first output having a predetermined voltage level and wherein the output terminals of the voltage conversion circuit loops of the second group provides the electronic device with a second output of the predetermined voltage level, the first output and the second output being connected to a common node point, so as to supply a single output having the predetermined voltage level to the electronic device.

6. The adaptive power supply system as claimed in claim 5, wherein each voltage conversion circuit loop comprises at least one switching circuit and a choke connected in series.

7. The adaptive power supply system as claimed in claim 6 further comprising a controller generating control signals respectively coupled to and controlling the switching circuit of the respective voltage conversion circuit loop.

8. The adaptive power supply system as claimed in claim 7, wherein the controller comprises a pulse width modulation control circuit.

9. The adaptive power supply system as claimed in claim 5, wherein the first output provided by the first group and the second output provided by the second group further pass through a filter.

10. The adaptive power supply system as claimed in claim 5, wherein the power source comprises a switching power supply.
